(19) United States
(12) Patent Application Publication
(10) Pub. No.: US 2005/0064268 A1
(43) Pub. Date: Mar. 24, 2005

(54) Fastening mechanism of a fuel cell stack

(76) Inventors: Kyu Taek Cho, Gwangmyeong-city (KR); Soo Whan Kim, Seongnam-city (KR); Woon Bong Hwang, Pohang-city (KR); Ji Hoon Jeon, Pohang-city (KR)

Correspondence Address: MORGAN, LEWIS & BOCKIUS LLP (SF), 2 PALO ALTO SQUARE, PALO ALTO, CA, 94306, US

(21) Appl. No.: 10/950,217

(22) Filed: Sep. 23, 2004

(30) Foreign Application Priority Data
Apr. 11, 2003 (KR) 10-2003-0077683

(51) Int. Cl. H01M 8/02

(52) U.S. Cl. 429/37

(57) ABSTRACT

A fastening mechanism of a fuel cell includes a pair of end plates for supporting the fuel cell stack by respectively being mounted to both ends of the fuel cell stack. A plurality of fastening bands elongated in an accumulation direction of the fuel cell stack pressurize the end plate by a predetermined pressure. Such a fastening mechanism enables uniform pressure on a separator and enhances sealing of a fuel cell stack.

### CROSS REFERENCE TO RELATED APPLICATION(S)

This application is based on, and claims priority from Korean Application No. 10-2003-0077683, filed on Nov. 4, 2003, the disclosure of which is incorporated herein by reference.

### TECHNICAL FIELD OF THE INVENTION

Generally, the present invention relates to a fuel cell. More particularly, a fastening mechanism of a fuel cell stack has a plurality of unit cells separated by separators, wherein surface pressure on the separators becomes more uniform by decreasing bending loads acting on the separators.

### BACKGROUND OF THE INVENTION

Typically, a fuel cell produces electric energy by reacting hydrogen H₂ and oxygen O₂ and includes a membrane-electrode assembly (MEA). The MEA includes an anode supplied with hydrogen H₂ and a cathode supplied with air, interposing an electrolyte membrane transmitting hydrogen ions H⁺ therebetween. Such MEAs and separators are alternately accumulated to form a fuel cell stack. A sum of output voltages of respective unit cells becomes an output voltage of the fuel cell stack.

Performance of a fuel cell stack may be measured as the scale of its output voltage, and the output voltage depends on a pressure formed between the separators. A separator of a fuel cell stack is usually made of a carbon fiber compound material, and a gasket is applied thereto to prevent leakage of fuel for an electrochemical reaction.

Hydrogen gas passing along a fuel passage formed on a side of a separator is supplied to an anode of an MEA through a gas diffusion layer (GDL) and the hydrogen gas is ionized at the anode. Such ionized hydrogen ions pass through the MEA and reach the cathode. At the cathode, air, more specifically, oxygen, passing along an air passage formed on a separator facing the cathode is ionized at the cathode and chemically reacts with the hydrogen ions to produce water and electricity.

Strength of a current output through electrodes, usually called current collectors, formed at both ends of a fuel cell stack may be used to evaluate efficiency of the fuel cell stack. A surface pressure formed between separators influences the strength of the output current. When the surface pressure is excessively small, contact resistance between separators is raised and thereby current conduction may fail. To the contrary, when the surface pressure is excessively high, the GDL may be excessively compressed such that gas does not efficiently diffuse through the GDL. Therefore, the strength of the current is maximized at a certain surface pressure between separators. Such an optimal surface pressure is attempted to be realized by a fastening device externally provided to the fuel cell stack.

A conventional fastening mechanism of a fuel cell stack includes two end plates for supporting a fuel cell stack at both ends thereof. A plurality of fastening bars for connecting the two end plates and fastening nuts for fixing the fastening bars to the end plates. A male thread is formed at each end of the fastening bars, and the fastening nuts are engaged with the fastening bars at the male thread. Therefore, surface pressure between separators of the fuel cell stack interposed between the two end plates may be adjusted by a fastening torque of the fastening nuts.

However, according to such a fastening mechanism, the end plates experience an undesired bending load by a gap between the fastening bars and the fuel cell stack. Therefore, the surface pressure between separators of the fuel cell stack disposed between the end plates may not be uniform over an entire area of the stack and sealing of the fuel cell stack may fail. In addition, the gap between the fastening bars and the fuel cell stack causes an increase in the entire volume.

In order to solve the above-described problem, U.S. Pat. No. 6,270,917 B1 discloses a fastening mechanism in which a fastening bar penetrates the separator to prevent such a volumetric increase. However, in this case, a separator should be newly designed from a conventional one, and a fastening bar penetrating a separator causes a structure of a fuel cell stack to be more complex.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

A motivation for the present invention is to provide a fastening mechanism of a fuel cell stack having non-limiting advantages of providing uniform pressure acting on separators by reducing an undesired bending load and providing enhanced sealing characteristic of a fuel cell stack. Another motivation for the present invention is to provide a fastening mechanism of a fuel cell stack having the non-limiting advantages of easy assembly and a simple structure.

Hereinafter, for a fuel cell stack of a rectangular hexahedral shape, sides thereof provided with end plates are called end sides, and other sides are called lateral sides. An intersecting line between adjacent lateral sides is called an edge.

An exemplary fastening mechanism according to an embodiment of the present invention fastens a fuel cell that includes an accumulation of membrane-electrode assemblies and separators alternately disposed therein. Such a fastening mechanism includes a pair of end plates for supporting the fuel cell stack by respectively being mounted to both ends of the fuel cell stack and a plurality of fastening bands elongated in an accumulation direction of the fuel cell stack for pressurizing the end plate by a predetermined pressure.

In a further embodiment, the plurality of fastening bands forms a predetermined residual stress and the predetermined pressure on the end plate is formed by the residual stress. In a still further embodiment, the fuel cell stack is of a rectangular hexahedral shape and the plurality of fastening bands comprise generally U-shaped fastening bands elongated in the accumulation direction of the fuel cell stack. A connected end portion of the U-shaped fastening band wraps an end plate of the end plate pair and an open end portion of the U-shaped fastening band elastically presses on another end plate of the end plate pair.

In a still further embodiment, the plurality of fastening bands includes first and second fastening bands and connected end portions of the first and second fastening bands wrap different end plates. Extension portions of the first and second fastening bands lie on different lateral sides. Alternatively, the plurality of fastening bands includes first and second fastening bands, wherein connected end portions of the first and second fastening bands wrap a same end plate. Extension portions of the first and second fastening bands lie on a same lateral side. Alternatively, the plurality of fastening bands includes first and second fastening bands wherein connected end portions of the first and second fastening bands wrap different end plates. Extension portions of the first and second fastening bands lie on a different edges.

In another further embodiment, the plurality of fastening bands includes an I-shaped fastening band elongated in the accumulation direction of the fuel cell stack and the I-shaped fastening band extends from one end plate to another end plate. In a further embodiment, the plurality of fastening bands include U-shaped first and second fastening bands and I-shaped third and fourth fastening bands. Connected end portions of the first and second fastening bands wrap different end plates. Extension portions of the first and second fastening bands lie on different edges and the third and fourth fastening bands extend on lateral sides parallel to each other.

In a further embodiment, the plurality of fastening bands further includes I-shaped fifth and sixth fastening bands wherein the fifth and sixth fastening bands extend on lateral sides that are parallel to each other and different from the lateral sides on which the third and fourth fastening bands lie. In another further embodiment, the fuel cell stack is of a rectangular hexahedral shape and the plurality of fastening bands comprises I-shaped first and second fastening bands elongated in the accumulation direction of the fuel cell stack. Both ends of the first and second fastening bands are bent such that the end plates of the fuel cell stack becomes elastically pressed by the ends.

In a further embodiment, a fastener for fastening ends of the plurality of the fastening bands is included. The fastener may be realized by a bolt, a rivet, a welding agent, or the like. Another exemplary fastening mechanism fastens a fuel cell including an accumulation of membrane-electrode assemblies and separators alternately disposed therein. Such a fastening mechanism includes a pair of end plates for supporting the fuel cell stack by respectively being mounted to both ends of the fuel cell stack. A plurality of fastening bands that are elongated in an accumulation direction of the fuel cell stack. Both ends of each of the fastening bands are fixed to a pair of end plates, wherein a plurality of slits are formed at edges of the pair of end plates. An end of each of the plurality of the fastening bands is formed larger than the slits and another end of each of the plurality of fastening bands is of an arrow shape such that the plurality of fastening bands is slidably inserted through the slits of the pair of end plates.

### BRIEF DESCRIPTION OF THE DRAWINGS

The accompanying drawings, which are incorporated in and constitute a part of the specification, illustrate embodiments of the present invention, and, read together with the detailed description, serve to explain the principles of the invention in which:

FIG. 1 illustrates a fastening mechanism of a fuel cell stack according to a first embodiment of the present invention;

FIG. 2 illustrates conjunction of a fastening band and an end plate according to an embodiment of the present invention;

FIG. 3 illustrates a fastening mechanism of a fuel cell stack according to a second embodiment of the present invention;

FIG. 4 illustrates a fastening mechanism of a fuel cell stack according to a third embodiment of the present invention;

FIG. 5 illustrates a fastening mechanism of a fuel cell stack according to a fourth embodiment of the present invention;

FIG. 6 illustrates a fastening mechanism of a fuel cell stack according to a fifth embodiment of the present invention;

FIG. 7 illustrates a fastening mechanism of a fuel cell stack according to a sixth embodiment of the present invention;

FIG. 8 illustrates a fastening mechanism of a fuel cell stack according to a seventh embodiment of the present invention;

FIG. 9 illustrates a fastening mechanism of a fuel cell stack according to an eighth embodiment of the present invention; and

FIG. 10 illustrates details of fastening bands shown in FIG. 9.

### DETAILED DESCRIPTION OF PREFERRED EMBODIMENTS

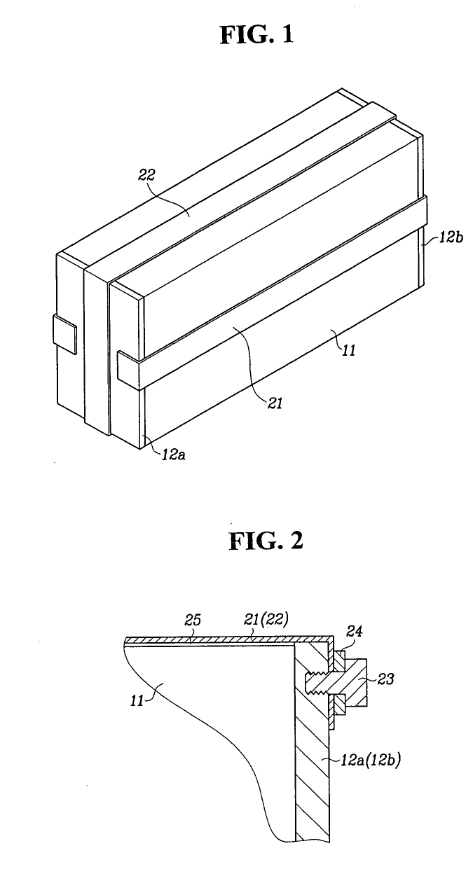

Referring to FIG. 1, a fastening mechanism of a fuel cell stack includes membrane-electrode assemblies and separators alternately stacked to form a fuel cell stack 11. End plates 12a and 12b are respectively mounted to both ends of the fuel cell stack 11. A first fastening band 21 and a second fastening band 22 are preferably designed to be generally U-shaped. The first fastening band 21 extends over two lateral sides of the fuel cell stack 11 that are generally parallel to each other. The second fastening band extends over lateral sides that are parallel to each other and different from the lateral sides over which the first fastening band lies.

Open end portions of the first and second fastening bands 21 and 22 elastically press different end plates 12a and 12b. Preferably, the first and second fastening bands 21 and 22 do not overlap. Both ends of an open end portion of the U-shaped first and second fastening bands 21 and 22 are inwardly bent. The end plates 12a and 12b are pressed at a predetermined pressure by a residual stress formed at the first and second fastening bands 21 and 22. For enhancing strength and preventing corrosion, the first and second fastening bands 21 and 22 are made of stainless steel or glass fiber reinforced plastics. The end plates 12a and 12b are made of an aluminum alloy, stainless steel, oriented glass fiber reinforced plastics, or the like.

The U-shaped first and second fastening bands 21 and 22 may be fixed to the end plates 12a and 12b by fasteners. An insulator film may be interposed between the lateral sides of the fuel cell stack 11 and the first and second fastening bands 21 and 22.

FIG. 2 shows a partial sectional view of a fastening mechanism of a fuel cell stack provided with such a fastener and an insulator film. The end plates 12a and 12b are fastened by a bolt 23 and the first and second fastening bands 21 and 22. A washer 24 is interposed between the bolt 23 and the first and second fastening bands 21 and 22. However, in an alternative embodiment, the fastener may be realized by a rivet, a welding agent, or the like in place of the bolt 23.

The insulator film 25, interposed between the first and second fastening bands 21 and lateral sides of the fuel cell stack 11, may preferably be made of teflon, a nonconductive polymer material, or the like.

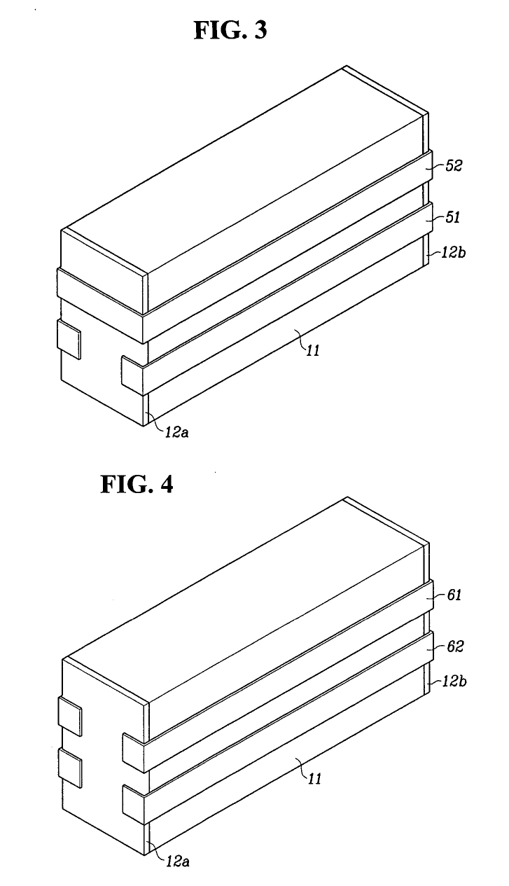

FIG. 3 illustrates a fastening mechanism of a fuel cell stack according to a second embodiment of the present invention. According to this embodiment, the fastening mechanism is used on the same fuel cell stack 11 and end plates 12a and 12b that have been described in connection with the first embodiment of the present invention. Hereinafter, features of the second embodiment different from the first embodiment of the present invention shown in FIG. 1 are described in detail. A U-shaped first fastening band 51 extends over two lateral sides of the fuel cell stack 11 that are substantially parallel to each other. Another U-shaped second fastening band 52 extends over the same lateral sides of the fuel cell stack 11. Open end portions of the first and second fastening bands 51 and 52 elastically press different end plates 12a and 12b, and the first and second fastening bands 51 and 52 preferably do not overlap. It is preferable that the first and second fastening bands 51 and 52 extend over two lateral sides of the fuel cell stack 11 that are wider than the other two lateral sides.

FIG. 4 illustrates a fastening mechanism of a fuel cell stack according to a third embodiment of the present invention. Accordingly, this fastening mechanism is primarily similar to one according to a second embodiment of the present invention. However, a substantial difference lies in that open end portions of first and second fastening bands 61 and 62 elastically press the same end plate 12a of the fuel cell stack 11.

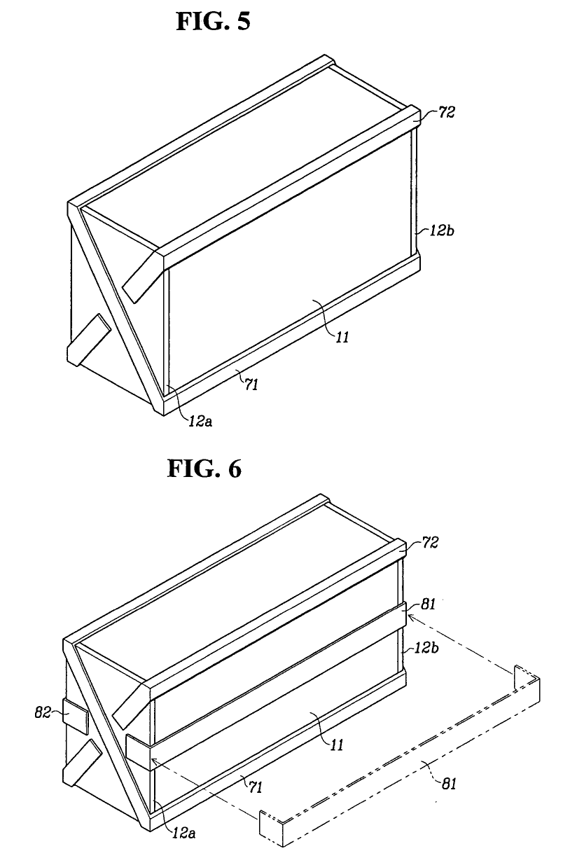

According to FIG. 5, a U-shaped first and second fastening bands 71 and 72 extend over different edges. Open end portions of the first and second fastening bands 71 and 72 elastically press different end plates 12a and 12b. Furthermore, the first and second fastening bands 71 and 72 do not overlap. That is, the first fastening band 71 extends over diagonally opposing edges, and the second fastening band 72 extends over diagonally opposing edges different from the edges related to the first fastening band 71. The first and second fastening bands 71 and 72 that extend over the edges of the fuel cell stack 11 are preferably formed in shapes corresponding to the shapes of the edges.

FIG. 6 shows a fifth embodiment of the present invention in which third and fourth fastening bands 81 and 82 are added to a fastening mechanism of another embodiment of the present invention, such as that shown in FIG. 5. According to this embodiment, the third and fourth fastening bands 81 and 82 are designed to be I-shaped and extend in an accumulation direction of the fuel cell stack 11 over two lateral side of the fuel cell stack 11 relatively parallel to each other. Both ends of the I-shaped third and fourth fastening bands 81 and 82 elastically press different end plates 12a and 12b, and the first, second, third, and fourth fastening bands 71, 72, 81, and 82 do not overlap.

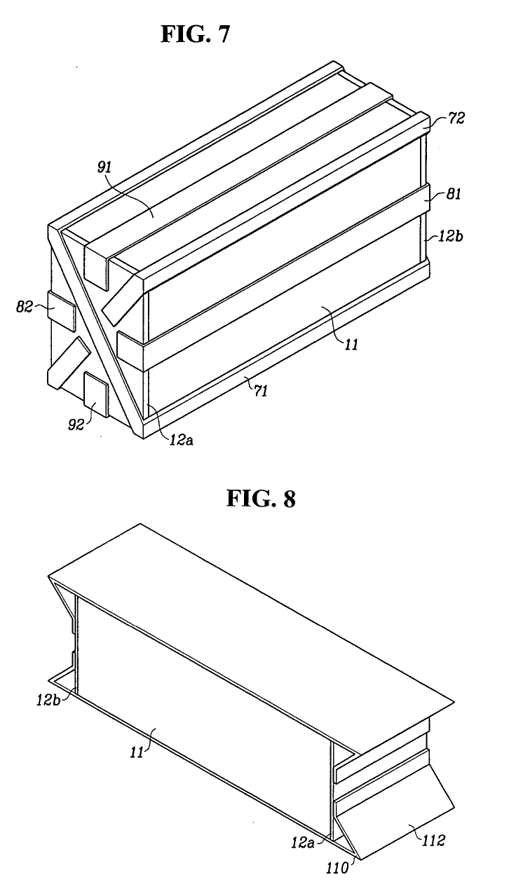

FIG. 7 illustrates a fastening mechanism of a fuel cell stack in which fifth and sixth fastening bands 91 and 92 are added to a fastening mechanism of a fifth embodiment of the present invention, such as that shown in FIG. 6.

The fifth and sixth fastening bands 91 and 92 are I-shaped, generally the same as the third and fourth fastening bands 81 and 82. The fifth and sixth fastening bands extend in the accumulation direction of the fuel cell stack 11 over two lateral sides different from the lateral sides over which the third and fourth fastening bands 81 and 82 extend. However, similar to the third and fourth fastening bands 81 and 82, both ends of the I-shaped fifth and sixth fastening bands 91 and 92 elastically press different end plates 12a and 12b. The first, second, third, fourth, fifth, and sixth fastening bands 71, 72, 81, 82, 91, and 92 do not overlap.

FIG. 8 illustrates a fastening mechanism of a fuel cell stack in which the fuel cell stack 11 is of a rectangular hexahedral shape, similar to the previous embodiments described herein. Such a seventh embodiment includes end plates 12a and 12b mounted to ends of the fuel cell stack 11 and I-shaped first and second fastening bands 110 and 112. The first and second fastening bands 110 and 112 extend in a lengthwise direction of the fuel cell stack 11 and wrap two lateral sides parallel to each other.

Widths of the first and second fastening bands 110 and 112 are the same as the widths of the lateral sides. The first and second fastening bands 110 and 112 exteriorly protrude from the end plates 12a and 12b, and both ends thereof are bent toward the end plates 12a and 12b such that they elastically press the end plates 12a and 12b. By changing the amount of bending of the first and second fastening bands 110 and 112, the surface pressure acting on separators in the accumulation direction of the fuel cell stack 11 can be changed.

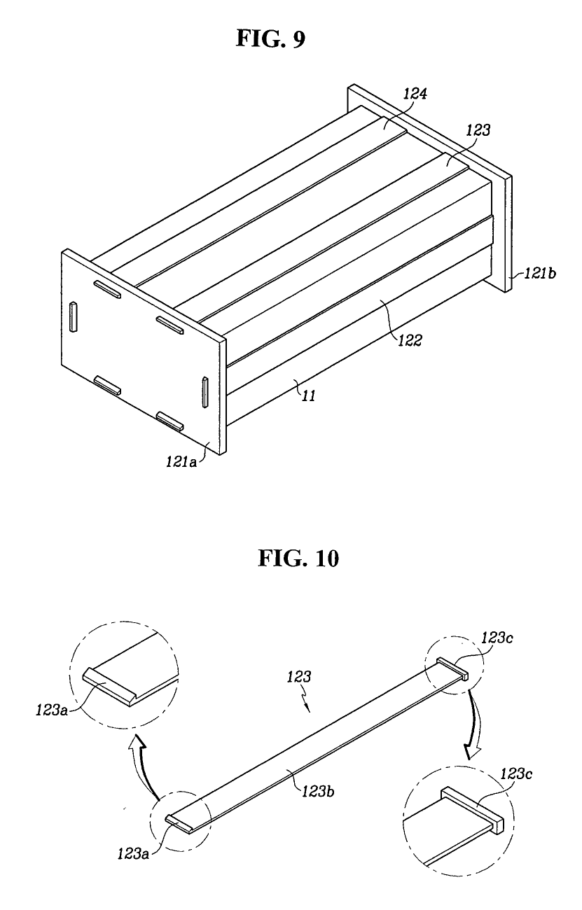

FIG. 9 illustrates a fastening mechanism of a fuel cell stack in which the fastening mechanism includes end plates 121a and 121b and a plurality of fastening bands 122, 123, and 124. A plurality of slits are formed at edges of the end plates 121a and 121b. The plurality of slits are symmetrically formed around the fuel cell stack, and corresponding slits on the end plates 121a and 121b confront each other such that each of the fastening bands 122, 123, and 124 connects the end plates 121a and 121b through the corresponding slits. The number of slits on one end plate 121a or 121b equals the number of fastening bands. For example, six slits and fastening bands may be formed, however, it should not be understood that the scope of the present invention is limited thereto. Each of the fastening bands 122, 123, and 124 are formed in the same shape, and for example, the fastening band 123 is illustrated in FIG. 12 in detail.

As shown in FIG. 10, one end 123c of the fastening bands 122, 123, and 124 is bigger than the slit and the other end 123a is formed in an arrow shape. In addition, an extension portion between the two ends 123a and 123c is smaller than the slit. Therefore, the fastening bands 122, 123, and 124 may be easily inserted through a slit of one end plate and subsequently through a corresponding slit of the other end plate.

Fastening bands 122, 123, and 124 are fixed between the end plates 121a and 121b in such a manner as to press the fuel cell stack 11 at a predetermined pressure in the accumulation direction and to form a desired surface pressure of the fuel cell stack. According to a fastening mechanism of a fuel cell stack of an embodiment of the present invention, an undesired bending load is minimized and sealing of a fuel cell stack is enhanced. In addition, wasted exterior volume is minimized such that an entire volume of a fuel cell stack may be more compact. Additionally, the fastening structure may be simplified and enhanced without substantially changing structural features of a fuel cell stack.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A fastening mechanism of a fuel cell comprising an accumulation of membrane-electrode assemblies and separators alternately disposed therein, the fastening mechanism comprising:
a pair of end plates for supporting the fuel cell stack by respectively being mounted to both ends of the fuel cell stack; and
a plurality of fastening bands elongated in an accumulation direction of the fuel cell stack for pressurizing the end plate by a predetermined pressure.

2. The fastening mechanism of claim 1, wherein the plurality of fastening bands forms a predetermined residual stress and the predetermined pressure on the end plate is formed by the residual stress.

3. The fastening mechanism of claim 2, wherein:
the fuel cell stack is of a rectangular hexahedral shape;
the plurality of fastening bands comprises a U-shaped fastening band elongated in the accumulation direction of the fuel cell stack;
a connected end portion of the U-shaped fastening band wraps an end plate of the end plate pair; and
an open end portion of the U-shaped fastening band elastically presses on another end plate of the end plate pair.

4. The fastening mechanism of claim 3, wherein:
the plurality of fastening bands comprises first and second fastening bands;
connected end portions of the first and second fastening bands wrap different end plates; and
extension portions of the first and second fastening bands lie on different lateral sides.

5. The fastening mechanism of claim 3, wherein:
the plurality of fastening bands comprises first and second fastening bands;
connected end portions of the first and second fastening bands wrap a same end plate; and
extension portions of the first and second fastening bands lie on a same lateral side.

6. The fastening mechanism of claim 3, wherein:
the plurality of fastening bands comprises first and second fastening bands;
connected end portions of the first and second fastening bands wrap different end plates; and
extension portions of the first and second fastening bands lie on different edges.

7. The fastening mechanism of claim 3, wherein:
the plurality of fastening bands comprises an I-shaped fastening band elongated in the accumulation direction of the fuel cell stack; and
the I-shaped fastening band extends from one end plate to another end plate.

8. The fastening mechanism of claim 7, wherein:
the plurality of fastening bands comprises U-shaped first and second fastening bands and I-shaped third and fourth fastening bands; and
connected end portions of the first and second fastening bands wrap different end plates;
extension portions of the first and second fastening bands lie on different edges; and
the third and fourth fastening bands extend on lateral sides parallel to each other.

9. The fastening mechanism of claim 8, wherein:
the plurality of fastening bands further comprises I-shaped fifth and sixth fastening bands; and
the fifth and sixth fastening bands extend on lateral sides that are parallel to each other and different from the lateral sides on which the third and fourth fastening bands lie.

10. The fastening mechanism of claim 2, wherein:
the fuel cell stack is of a rectangular hexahedral shape;
the plurality of fastening bands comprises I-shaped first and second fastening bands elongated in the accumulation direction of the fuel cell stack; and
both ends of respective first and second fastening bands are bent such that the end plates of the fuel cell stack becomes elastically pressed by the ends.

11. The fastening mechanism of claim 1, further comprising an insulator film disposed between the fastening bands and the fuel cell.

12. The fastening mechanism of claim 11, wherein the fastening band is made of a fiber reinforced polymer material.

13. The fastening mechanism of claim 11, wherein the fastening band is made of stainless steel.

14. The fastening mechanism of claim 11, further comprising a fastener for fastening ends of the plurality of the fastening bands.

15. The fastening mechanism of claim 14, wherein the fastener selected from the group consisting of a bolt, a rivet, or a welding agent.

16. A fastening mechanism of a fuel cell comprising an accumulation of membrane-electrode assemblies and separators alternately disposed therein, the fastening mechanism comprising:
a pair of end plates for supporting a fuel cell stack by respectively being mounted to both ends of the fuel cell stack; and
a plurality of fastening bands elongated in an accumulation direction of the fuel cell stack, both ends of each of the fastening bands being fixed to the pair of end plates, wherein;
a plurality of slits are formed at edges of the pair of end plates;
an end of each of the plurality of the fastening bands is formed larger than the slits; and
another end of each of the plurality of the fastening bands is of an arrow shape such that the plurality of fastening bands is slidably insertable through the slits of the pair of end plates.

17. The fastening mechanism of claim 16, further comprising an insulator film disposed between the fastening bands and the fuel cell stack.

18. The fastening mechanism of claim 17, wherein the fastening band is made of a fiber reinforced polymer material.

19. The fastening mechanism of claim 17, wherein the fastening band is made of stainless steel.

20. A fastening mechanism for a fuel cell, comprising:
a pair of end plates configured and dimensioned to support a fuel cell stack by respectively being mounted to alternate ends of the fuel cell stack; and
a plurality of fastening bands elongated in an accumulation direction of the fuel cell stack, said fastening bands configured to apply a predetermined pressure to respective end plates.
